(19) United States
(12) Patent Application Publication
(10) Pub. No.: US 2026/0368515 A1
(43) Pub. Date: Nov. 19, 2026

(54) METHOD OF DETERMINING AN ANOMALOUS COOKING EVENT

(71) Applicant: EATON INTELLIGENT POWER LIMITED, Dublin 4 (IE)

(72) Inventors: Suchandra MANDAL, Salthill Galway (IE); Verma RAJAN, Dublin (IE)

(21) Appl. No.: 19/148,373

(22) PCT Filed: Apr. 20, 2023
(86) PCT No.: PCT/EP2023/060220

§ 371 Date: Jul. 16, 2025

(30) Foreign Application Priority Data
Feb. 6, 2023 (IN) 202311007373

(51) Int. Cl. G06N 3/08

(52) U.S. Cl. CPC G06N 3/08

(57) ABSTRACT

Some embodiments relate to a computer-implemented method of determining an anomalous cooking event of an electrical appliance. The method includes receiving sensor output data from one or more sensors indicative of usage of the electrical appliance. The sensor output data can include electrical powerline data from an electrical powerline sensor or sensors. the method further including determining a start of a cooking event of the electrical appliance based on the received electrical powerline data; determining an ongoing cooking event profile for the electrical appliance based on the sensor output data received since the determined start of the cooking event; determining a representative cooking event profile representing normal usage of the electrical appliance comparing the ongoing cooking event profile to the representative cooking event profile; and determining if the ongoing cooking event is anomalous in dependence on the comparison.

### CROSS-REFERENCE TO RELATED APPLICATIONS

This application is a national phase filing under 35 C.F.R. § 371 of and claims priority to PCT Patent Application No. PCT/EP 2023/060220, filed on Apr. 20, 2023, which claims the benefit of Indian Application No. 202311007373, filed on Feb. 6, 2023, the contents of which are hereby incorporated in their entireties by reference.

### TECHNICAL FIELD

The presently disclosed subject matter relates to a computer-implemented method of detecting anomalous cooking events of an electrical appliance.

### BACKGROUND

Many modern homes are fitted with electrical cooking appliances, such as ovens or hobs. However, if an appliance is accidentally left on after a user has cooked a meal, the hob or oven can continue exuding heat to the environment, which can create a hazardous situation with an increased risk of damage to the appliance or of fire.

Naturally, it is therefore of interest to find a way to monitor electrical cooking appliances such that hazardous situations can be avoided.

It is against this background that the presently disclosed subject matter has been devised.

### SUMMARY OF THE DISCLOSURE

According to a first aspect of the presently disclosed subject matter, there is provided a computer-implemented method of determining an anomalous cooking event of an electrical appliance. The method comprises: receiving sensor output data from one or more sensors indicative of usage of the electrical appliance, the sensor output data comprising electrical powerline data from an electrical powerline sensor; determining a start of a cooking event of the electrical appliance based on the received electrical powerline data; determining an ongoing cooking event profile for the electrical appliance based on the sensor output data received since the determined start of the cooking event; determining a representative cooking event profile representing normal usage of the electrical appliance, wherein the determination of the representative cooking event profile uses a library of stored data indicative of usage of the electrical appliance and is based on a time of the determined start of the cooking event; comparing the ongoing cooking event profile to the representative cooking event profile; and determining if the ongoing cooking event is anomalous in dependence on the comparison.

The presently disclosed subject matter therefore provides a method of detecting cooking events that do not fit with ‘normal’ usage of a particular electrical appliance. By detecting such anomalous events, potentially hazardous events can be avoided. By determining a representative cooking event profile of a particular electrical appliance, the determination of whether a cooking event is anomalous is specific to the typical usage of that particular appliance, or users/household, which allows greater accuracy and specificity of the method.

The library may comprise a plurality of individual data sets relating to previous cooking events. The method may comprise determining that the ongoing cooking event has finished and then storing sensor output data related to the ongoing cooking event in the library as a new data set.

The representative cooking event profile may be determined using a cooking event model generated by a neural network. Accordingly, the method in this case may comprise training the neural network on the data in the library. The method may further comprise retraining the neural network such that the neural network is trained on data added to the library since the neural network was last trained. The new cooking event model generated by retraining the neural network may be compared with the current cooking event model to determine which cooking event model should be used in the method.

The determination of the representative cooking event profile may be based on a time profile of the cooking event, wherein the time profile comprises a time of day, day of the week and month of the year of the determined start of the cooking event.

The one or more electrical powerline sensor or sensors may be part of a smart circuit breaker. One or more sensors may comprise a temperature sensor.

The method may comprise determining an urgency status of the cooking event if the cooking event is determined to be anomalous. The determination of the urgency status of the cooking event may be based on a temperature measured by the temperature sensor, such as an ambient temperature of the room in which the electrical appliance is located.

The method may comprise generating an alert to a user of the electrical appliance if the cooking event is determined to be anomalous. The alert may be generated in dependence on the determined urgency status of the cooking event.

The alert may comprise a list of selectable control actions in response to the anomalous cooking event. The list of selectable control actions may comprise causing the smart circuit breaker to cut off or interrupt an electrical supply to the electrical appliance and/or calling emergency services. The list of selectable control actions may be generated in dependence on the determined urgency status of the cooking event.

The method may comprise automatically selecting a control action from the list if no response is received from a user of the electrical appliance within a predetermined time period. The automatically-selected control action may depend on the determined urgency status of the cooking event.

The method may comprise repeating the steps of determining an ongoing cooking event profile, comparing the determined ongoing cooking event profile to the representative cooking event profile and determining if the ongoing cooking event profile is anomalous in dependence on the comparison. The method may be repeated every hour, every thirty minutes, every ten minutes, every five minutes, every minute, every thirty seconds, or every ten seconds.

The step of comparing the ongoing cooking event profile to the representative cooking event profile may comprise comparing a mean or instant value of a parameter of the sensor output data in the ongoing cooking event profile to a mean or instant value of the same parameter in the representative cooking event profile. The method may comprise calculating an error value based on the difference between the values of the parameter in the ongoing cooking event profile and the representative cooking event profile, and determining that the ongoing cooking event is anomalous if the error value is greater than a threshold value. The threshold value may be defined with respect to a standard deviation of the parameter in the representative cooking event profile.

According to a second aspect of the presently disclosed subject matter, there is provided a non-transitory, computer readable storage medium storing instructions thereon which, when executed by one or more computer processors, cause the one or more processors to perform the method described above.

According to a third aspect of the presently disclosed subject matter, there is provided a processor configured to carry out the method described above, optionally by reading the computer readable instructions referenced above.

It will be understood that individual features of the presently disclosed subject matter may be combined where appropriate while still falling within the scope of the appended claims, which define the protection sought.

### BRIEF DESCRIPTION OF THE DRAWINGS

Examples of the presently disclosed subject matter will now be described with reference to the accompanying drawings, in which:

FIG. 1 shows a schematic diagram of a home with electrical appliances; and

FIG. 2 shows a flow chart depicting steps of a method in accordance with an aspect of the presently disclosed subject matter.

### DETAILED DESCRIPTION

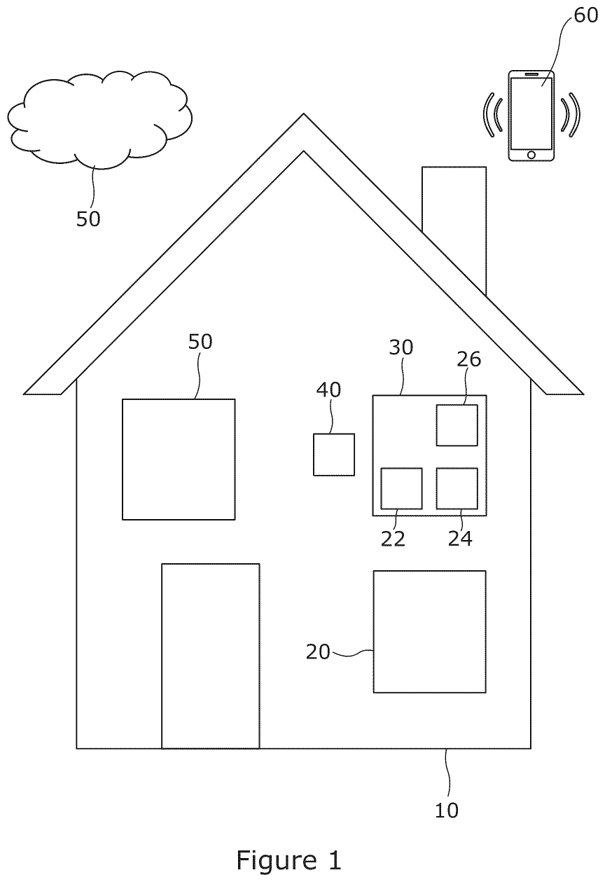

FIG. 1 shows a home 10 with an electrical appliance 20. The electrical appliance 20 may in particular be a cooking appliance, such as a hob, a grill or an oven. Typically, cooking appliances in a home will be located within a given room of the home, specifically a kitchen (not shown) of the home 10. The home 10 also comprises a variety of sensors that are configured to measure various parameters of interest associated with the electrical appliance 20. In particular, the sensors may include sensors configured to measure electrical powerline data of the electrical appliance 20. The electrical powerline data of the electrical appliance 20 may relate to various electrical parameters, such as current, power and voltage and so may include at least one of a current drawn by the electrical appliance 20, a power drawn by the electrical appliance 20, or a voltage drop across the electrical appliance 20 and so the sensors may comprise one or more of a power meter 22, an ammeter 24 and a voltmeter 26. The power meter 22, ammeter 24 and voltmeter 26 may measure the respective parameters of interest at set intervals, or may do so continuously. If the parameters are measured at set intervals, the intervals must be frequent enough such that anomalous cooking events are detected quickly enough to avoid becoming hazardous.

As shown in FIG. 1, the sensors may be comprised within a so-called ‘smart’ circuit breaker 30, which has the additional functionality of being able to cut off the electrical supply to the electrical appliance 20 under certain conditions. The smart circuit breaker 30 may be connected to multiple such electrical appliances 20 in the home 10. The sensors in the home 10 may also comprise a temperature sensor 40, which is configured to measure the ambient temperature in the vicinity of the electrical appliance 20. For example, the temperature sensor 40 may be located in the same room as the electrical appliance 20 and measures the ambient temperature in the room. The temperature sensor 40 may be a standalone device, or may be comprised as part of another device, such as the electrical appliance 20.

The sensors are in communication, e.g. wireless communication, with a processor 50 such that data output by the sensors from measurements they make of the respective parameters of interest can be processed as discussed in greater detail below. The processor 50 may be onsite, e.g. as part of a standalone device, or may be located remotely from the home 10, e.g. in the Cloud: both options are shown in FIG. 1. The processor 50 may also be configured to act as a controller for the wider sensing system, including the sensors 22, 24, 26, the smart circuit breaker 30 and the temperature sensor 40. In the example shown in FIG. 1, the sensor output data comprises electrical powerline data from the power meter 22, ammeter 24 and voltmeter 26 and also temperature data from the temperature sensor 40. If the processor 50 is located onsite, it will be appreciated by the skilled person that the functionality of the processor 50 may be incorporated into one of the sensors, such as the temperature sensor 40, or the smart circuit breaker 30.

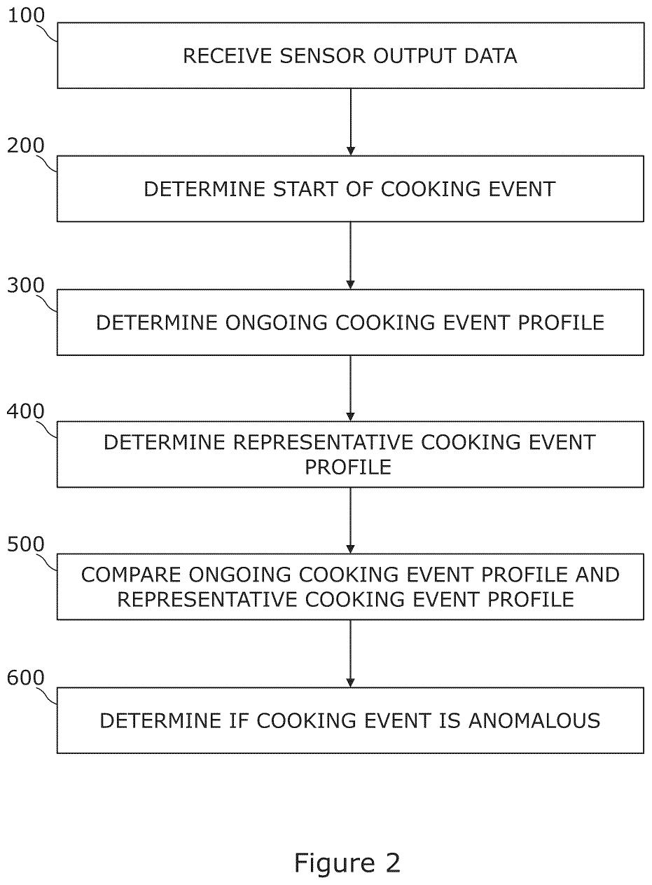

FIG. 2 shows the steps of a method in accordance with examples of the presently disclosed subject matter.

At step 100, real-time sensor output data recorded by the sensors is received by the processor 50. For example, in the arrangement shown in FIG. 1, the sensor output data comprises temperature data from the temperature sensor 40 and electrical powerline data from the smart circuit breaker 30, itself comprising power data from the power meter 22, current data from the ammeter 24 and/or voltage data from the voltmeter 26. The processor 50 may receive the sensor output data from the sensors via direct connections, such as optic fibres or electrical wires, but may also receive the sensor output data wirelessly via standard wireless communication mechanisms such as WiFi, Bluetooth, etc. Wireless transfer of the sensor output data to the processor 50 may be particularly preferred if the processor 50 is located remotely from the home 10.

At some point, the user of the electrical appliance 20 will turn the electrical appliance 20 on and will start cooking. At step 200, the processor 50 determines the start of a cooking event based on the electrical powerline data received from the smart circuit breaker 30. For example, the start of the cooking event may be determined by any of the values of the power data, current data or voltage data, as measured by the smart circuit breaker 30, exceeding a predetermined threshold value that is representative of the electrical appliance 20 being in operation, or turned on. In the case that multiple electrical appliances 20 are connected via the same powerline, it is possible to for the processor 50 distinguish which electrical appliance 20 the sensor output data relates to.

It will be understood that this may occur in a number of ways. For example, it may be the case that more than one of the electrical powerline data parameters, such as the value of the power data needs to exceed its threshold value in order for a cooking event to be determined to have started. In other situations, more than one, or even all of the different electrical powerline data parameters may need to exceed their respective threshold values in order for the processor 50 to determine that the cooking event has started. The processor 50 records the time at which the cooking event is determined to have started once this determination is made, so that a duration of the cooking event may be calculated, as discussed below. It will also be appreciated that an end of the cooking event may be determined in much the same way, by comparing the electrical powerline data parameters with respective threshold values, with the end of the cooking event determined when one, some or all of the electrical powerline data parameters is, or are, below the respective threshold value for that parameter. The threshold values may be predefined or could be values learned by the processor 50 as values that the respective electrical powerline data parameters take when the electrical appliance 20 is switched on.

At step 300, an ongoing cooking event profile is determined by the processor 50 based on the sensor output data received from the smart circuit breaker 30 and/or the temperature sensor 40 since the determined start of the cooking event. The sensor output data is therefore used to build the ongoing cooking event profile to represent the ongoing cooking event. The ongoing cooking event profile may comprise the current value (i.e. the value at a current time step or most recent time step), the mean and the standard deviation (or other statistical dispersion parameter, such as variance) of each sensor output data parameter since the determined start of the cooking event as well as the (current) elapsed time (since the start) of the cooking event at the time of the determination of the ongoing cooking event profile. The ongoing cooking event profile therefore represents a statistical picture of the cooking event up until the point that the profile is generated.

At step 400, the processor 50 determines a representative cooking event profile. The representative cooking event profile, in contrast to the ongoing cooking event profile, represents a statistical picture of an expected cooking event. In other words, the representative cooking event profile is intended to represent ‘normal’ use of the electrical appliance 20, and can be viewed as an attempt to re-create an expected profile for the ongoing cooking event profiles that will be generated by the processor 50.

Each individual home 10, or indeed any building, such as a restaurant kitchen, has ‘normal’ usage patterns for an electrical appliance 20 when cooking. This usage will tend to vary for different times of days, different days of the week and different months or seasons of the year. Knowledge of how usage of an electrical appliance 20 is personalised to an individual home can therefore be used and exploited to identify when usage of an electrical appliance is not normal in a certain instance and therefore may be hazardous.

As will be explained in greater detail below, the processor 50 compares the ongoing cooking event profile generated at step 300 to the representative cooking event profile. Naturally, therefore, the representative cooking event profile and the ongoing cooking event profile share a high level of similarity in terms of the variables and values comprised within each profile. While the representative cooking event profile naturally does not contain current values for any of the sensor output data parameters, it does comprise mean and standard deviation values for those parameters, in a similar way to the ongoing cooking event profile. The representative cooking event profile also comprises a representative, or expected, elapsed time, or duration of a cooking event, to enable comparison with the ongoing cooking event profile.

To build, or generate, the representative cooking event profile, the processor has access to a database, or library, which may be stored locally or remotely. The library contains data that is indicative of, or represents, usage of the electrical appliance 20. The library may be stored inside the processor 50, or may be stored remotely in the cloud.

For example, the library may contain sensor output data, or ongoing cooking event profiles, from previous cooking events using that particular electrical appliance 20, i.e. in the particular home 10, that have been recorded by the processor 50 and stored in the library. To store data from a cooking event, when the processor 50 determines that a cooking event has finished, it may calculate final values of certain parameters, such as the mean and standard deviation of each sensor output data parameter and the total time of the cooking event, i.e. the time between the start and end of the cooking event, e.g. the time from the appliance 20 being switched on to being switched off. These final values together make up a single data set, so that the data stored in the library are separated by the cooking event to which they relate. The individual data sets, therefore, substantially mirror the representative cooking event profile in terms of the type of numerical data contained therein. Advantageously, by only storing the data once the cooking event is determined to have ended, each data set reflects the whole of a cooking event, and not just a part thereof. By populating the library with data sets relating to use of the electrical appliance 20 within the home 10, it will be appreciated that the generation of the representative cooking event profile, and the determination of anomalous cooking events, as described below, is individually tailored to a particular user or household.

Prior to storage in the library, raw sensor output data can be enriched/labelled by the processor 50. In particular, the processor may add the time of day, day of the week and month of the year at which the start of the cooking event to which that set of data relates was determined to generate a time profile associated with each individual set of data. The processor 50 may generate the time profile at the time that the cooking event starts so when a cooking event is determined to have started, a time profile for that event is generated straight away. The processor 50 may also enrich the set of data by adding data related to the location of the electrical appliance 20 within the home 10, e.g. kitchen, and/or the type of electrical appliance 20, e.g. oven, to the set. This enables separation of the data sets by the electrical appliance 20 to which they relate, which can play a role in the determination of the representative cooking event profile as described below. It is especially important to add data related to the location of the electrical appliance 20 within the home and/or the type of electrical appliance 20 if the smart circuit breaker 30 is connected to multiple electrical appliances 20.

The library may also contain ‘dummy’ data sets that are pre-loaded into the library. The dummy data sets simulate real cooking event data so a representative cooking event profile can be determined, and an anomalous cooking event can be detected even when there is no past cooking event data, or very little past cooking event data, stored in the library, as might be the case when the electrical appliance 20 is new, or the user has just moved into the home 10. In some instances, the dummy data sets may include data sets recorded from an equivalent electrical appliance in a different home or location. However, this must be carefully selected so that the dummy data sets are likely to share similarities with the usage of the electrical appliance 20 in the home 10. For example, therefore, the dummy data sets may come from homes in the same region or country as the home 10. The processor generates the representative cooking event profile selecting data sets from the library and aggregating them. Aggregating the selected data sets results in the representative cooking event profile comprising mean and standard deviation values for numerical parameters, such as for the electrical powerline data parameters, temperature or total elapsed time of the cooking event across the entirety of the selected data sets. It is possible to aggregate all the data sets in the library to generate the representative cooking event profile. However, it is preferable that a subset of the data in the library is used to generate the representative cooking event profile, in order to tailor the representative cooking event profile more accurately to the expected cooking event and to the particular characteristics of how the cooking events initiated by the user on the electrical appliance 20 change over time.

To achieve this, the processor may only select data sets that have a similar time profile to the current ongoing cooking event when aggregating data sets from the library to generate the representative cooking event profile. Cooking habits generally change with seasons or times of the year, or at weekends compared to weekdays, or across a day such as differences between afternoon and evening meals. For instance, in winter, a user may cook more stews or other similar dishes where cooking is over a lower heat for a longer period of time. Similarly, a user may have more time to cook for longer at weekends compared to weekday evenings, or for evening meals compared to afternoon meals. The processor 50 may therefore define several selection criteria in order to select data sets that have a similar time profile to the ongoing cooking event.

For example, the processor 50 may apply a selection criterion based on the month of the year of the ongoing cooking event. This month-based selection criterion may exclude data sets that do not fall within a predetermined number of months from the month of the ongoing cooking event, or that do not fall within a seasonal grouping to which the ongoing cooking event belongs. If a seasonal grouping is to be used in the month-based selection criterion, the seasonal grouping must first be determined and input to the processor 50, as the seasonal grouping will necessarily vary based on location.

The processor 50 may also apply a selection criterion based on the day of the week of the ongoing cooking event. For example, the day-based selection criterion may exclude data sets where the day of the week does not match the day of the week of the ongoing cooking event. Alternatively, the day-based selection criterion may exclude data sets that do not fall within a day grouping to which the ongoing cooking event belongs. The day grouping may, for example, group days of the week into week days and weekend days. As with the month-based selection criterion above, if a day grouping is to be used in the day-based selection criterion, it must first be determined and input to the processor 50.

The processor 50 may also apply a selection criterion based on the time of day of the ongoing cooking event. As above with the month-and day-based criteria, the time-based criteria may exclude data sets that do not fall within a time grouping to which the ongoing cooking event belongs. The time grouping may, for example, group times of the day by expected periods for certain meals. If a time grouping is to be used, it must be determined and input to the processor 50, as in different locations, different local cultures may define different mealtimes throughout the day.

By selecting only data sets with similar time profiles to the ongoing cooking event when generating the representative cooking event profile, the processor 50 enables a more accurate representation of ‘normal’ use of the electrical appliance 20 to be generated, which increases the accuracy of the determination of whether or not the ongoing cooking event is anomalous.

If the type of electrical appliance 20 is included in the data sets stored in the library, the processor 50 may additionally only select data sets relating to that electrical appliance 20. This is because different electrical appliances are used very differently to each other: an oven cooks food very differently to a hob on a stove, for instance. However, if the location of a certain electrical appliance 20 is included in the data sets stored in the library, it may be beneficial to include other electrical appliances 20 of the same type from a different location. For instance, if the home 10 has more than one kitchen, the processor may select data sets for a particular type of electrical appliance 20 from all kitchens in the home 10 when generating the representative cooking event profile. This allows the sharing of data between electrical appliances 20 in different locations in the home 10.

The processor 50 may also determine the representative cooking event profile by using a neural network. Initially, the neural network undergoes a training phase in order to learn the habits of the user, or users, of the electrical appliance 20. The neural network is trained using the data sets in the library, such that it learns the distribution of cooking habits for the electrical appliance 20. In this way, by training the neural network on data sets, which represent completed cooking events, the neural network is able to more accurately learn how cooking events are carried out on the electrical appliance 20. Having learned the distribution of cooking habits for the electrical appliance 20, the neural network is able to generate a cooking event model, which is used to determine the representative cooking event profile.

When generating the representative cooking event profile, the neural network uses the cooking event model to attempt to generate a profile that corresponds to an ‘expected’ cooking event, given the time profile of the ongoing cooking event. Like the representative cooking event profile determined by the fixed selection criteria discussed above, the representative cooking event profile generated by the neural network must necessarily be an aggregation of the data sets comprised within the library, with some form of weighting factor applied to each data set to form the representative cooking event profile. The weighting factors applied to the data sets are influenced by the time profile associated with the ongoing cooking event and consequently take the month of the year, the day of the week and the time of day into account. Therefore, the neural network effectively applies its own selection criteria when using the cooking event model to generate the representative cooking event profile.

In this way, the use of a neural network has similarities with the fixed selection criteria described above. However, the use of a neural network and the associated cooking event model allows a much greater degree of flexibility in terms of how the representative cooking event profile is generated, ensuring it better reflects an ‘expected’ cooking event, which enables a more accurate determination of whether an ongoing cooking event is anomalous or not.

To ensure continued good performance of the neural network in generating representative cooking event profiles that lead to accurate determinations of whether an ongoing cooking event is anomalous, the neural network may be re-trained periodically. The re-training may occur at a set interval, such as once a week. Alternatively, or additionally, the neural network may be retrained when it is determined that the performance of the neural network has degraded such that the predictions made by the neural network (i.e. the representative cooking event profiles) are not relevant to the actual cooking events. This may occur if, for example, a predetermined number of successive cooking events are all determined to be anomalous. However, the skilled person will be aware of other methods to determine degradation of the performance of the neural network. To retrain the neural network, the data sets representing cooking events that have occurred and been stored in the library since the last time the neural network was trained are added to the set of training data.

Retraining the neural network means that a new cooking event model is also generated based on the updated training. As the neural network is retrained, therefore, multiple cooking event models will exist. In this case, the new cooking event model is compared with the current active cooking event model to determine which model has the least error in generating an expected cooking event. The two models may be compared through the mean error between the parameters of the two cooking event models and those of the ongoing cooking event profile, as discussed in further detail below with reference to identifying an anomalous cooking event, or through various other statistical measures known to the skilled person, such as the F-score or p-value.

With the representative cooking event profile determined by the processor 50 through use of a neural network or otherwise as described above, it is then compared to the ongoing cooking event profile at step 500. In this step, the mean value of each sensor output data parameter in the ongoing event profile is compared to the mean value of the same parameter in the representative cooking event profile. One exception to this is the elapsed time of the ongoing cooking event, which forms part of the ongoing cooking event profile as discussed above. There is, naturally, no mean value for this parameter in the ongoing cooking event profile and so it is only the instant elapsed time that is compared with the mean elapsed time of the aggregated data sets that make up the representative cooking event profile. In addition, only the mean value of the ambient temperature in the ongoing cooking event profile is compared to the mean value of the ambient temperature in the representative profile, even though the instant value of the ambient temperature also forms part of the ongoing cooking even profile. Each comparison between the ongoing cooking event profile and the representative cooking event profile generates an error value that represents the difference between the mean value of that parameter in the ongoing cooking event profile and the representative cooking event profile.

At step 600 the processor makes a determination as to whether the cooking event is anomalous based on the error values of the parameters in the ongoing cooking event profile. If the error value of a certain parameter or of certain parameters exceeds a predetermined threshold value, the cooking event is determined to be anomalous. It may be the case that for some parameters, such as the ambient temperature, the cooking event will be determined to be anomalous even if that is the only parameter with an error value that exceeds its predetermined threshold value, while for other parameters, it may be necessary that more than one parameter has an error value that exceeds its predetermined threshold value.

For certain parameters, such as the ambient temperature and the elapsed time of the cooking event, it may be necessary for the relevant value in the ongoing cooking event profile to be greater than the equivalent value in the representative cooking event profile for the ongoing cooking event to be considered to be anomalous. In the case of the elapsed time of the ongoing cooking event, this is because ongoing cooking event profiles may be repeatedly generated for any given cooking event as the cooking event progresses, as will be explained in greater detail below, and to determine a cooking event as being anomalous for being too short would result in most cooking events being considered anomalous when they had only just begun, which would decrease the utility of the method. On the other hand, in the case of the ambient temperature, this is because monitoring of the ambient temperature is primarily a safety concern, and so it is unnecessary to mark as anomalous a cooking event in which the ambient temperature is significantly lower than normal.

The threshold values for each parameter may be determined with respect to the standard deviation of that parameter in the representative cooking event profile. For example, the threshold value may be set as being a set number of standard deviations away from the mean value of that parameter in the representative cooking event profile. This set value of standard deviations may be an integer number, such as two or three, but may also fall in between integer values. The set number of standard deviations may be uniform across the different parameters in the representative cooking event profile and the ongoing cooking event profile, or may differ between parameters. It may also be the case that only some parameters have threshold values that are defined with respect to the standard deviation of those parameters in the representative cooking event profile, with others parameters defining the threshold values at a fixed level.

One advantage of defining the threshold values with respect to the standard deviation of a parameter in the representative cooking event profile is that the threshold value becomes adaptive with respect to changing patterns in usage of the electrical appliance 20. For example, if a particular user cooks in substantially the same way for every meal, the standard deviation of most, if not all, of the parameters comprising the representative cooking event profile will be very small, and so any different type of cooking will likely cause the error values created by comparison of the mean values of the parameters in the ongoing cooking event profile to those representative cooking event profile to exceed the threshold values and so cause the processor 50 to determine that the ongoing cooking event is anomalous. On the other hand, if a particular user cooks in a more varied fashion, the standard deviations and threshold values will be larger and so a greater deviation will be required from the mean value of the parameters in the representative cooking event profile for the processor 50 to determine a cooking event to be anomalous. The threshold values may also change over time as a user's cooking habits change over the course of a year and the data sets selected by the processor 50 for aggregation to generate the representative cooking event profile also change.

If the ongoing cooking event is determined to be anomalous, an alert is generated to the user. The alert may be an audible alert, a visual alert or may be pushed (wirelessly) from the processor 50 to a mobile device, such as a mobile phone 60, shown in FIG. 1. The alert informs the user that an anomalous event has occurred so that appropriate action may be taken. The alert may comprise a list of selectable control actions to enable the user of the electrical appliance 20 to take action in response to the determined anomalous event. The selectable control actions may include causing the smart circuit breaker 30 to cut off or interrupt the electrical supply to the electrical appliance 20 in case the electrical appliance 20 has been accidentally left on and the user is no longer in the same room or is out of the home 10. In principle, the selectable control actions may also include sending a control action from the mobile phone 60 to the electrical appliance 20 to turn the electrical appliance 20 off, or otherwise adjust a heating level of the electrical appliance 20. The selectable control actions may also include calling emergency services, as discussed in greater detail below. In addition, the selectable control actions may include ignoring the determination of the ongoing cooking event as anomalous and/or marking the ongoing cooking event as non-anomalous. This allows inconsequential or incorrect determinations of an anomalous event to be ignored or corrected.

If none of the control actions are selected by the user, the processor 50 may select an action automatically after a predetermined period of time. For example, if no control action is selected by the user, the processor 30 may cause the smart circuit breaker 30 to cut off or interrupt the electrical supply to the electrical appliance 20. This can be helpful in cases where the user has forgotten to turn the electrical appliance 20 off after finishing cooking as it helps to minimise wasted energy and protects the appliance. Alternatively, the processor 50 may automatically call the emergency services if no control action is selected by the user.

If the cooking event is determined to be anomalous, the processor 50 may also determine an urgency of the anomalous event. This helps to distinguish between anomalous events that pose limited or no danger, e.g. of fire or of damage to the appliance. The determination of the urgency of the anomalous event can be based on the degree of difference between the ongoing cooking event profile and the representative cooking event profile. In this scenario, therefore, two threshold values may be defined: a first threshold value that enables the processor 50 to determine if the cooking event is anomalous, and a second threshold value, representing a larger deviation from the representative cooking event profile, that enable the processor 50 to determine if the anomalous cooking event is urgent. The determination of whether an anomalous event is urgent or not may be made in dependence on certain parameters only. In particular, the determination of the urgency or otherwise of an anomalous event may be made in dependence on the error value of the ambient temperature. In this case, any ongoing cooking event determined to be anomalous as a result of the mean value of the ambient temperature being too high is automatically determined to be urgent. Alternatively, a determination that the anomalous event is urgent may be made if the error value determined for the ambient temperature is above the first threshold value for the determination of an anomalous event for a period of time that exceeds a predetermined period. This enables the processor to determine that an anomalous event, initially determined to be non-urgent, has become urgent as the cooking event progresses in time. Finally, the determination of the urgency of an anomalous event may also be made in dependence on the instant value of the ambient temperature exceeding a separate threshold value. This enables an urgent anomalous event to be determined without a need to wait for the mean value of the ambient temperature to increase.

The alert that is generated to the user of the electrical appliance 20 may distinguish between urgent and non-urgent anomalous events. For instance, the list of control actions that may be selected by the user may differ for urgent and non-urgent events. In this case, for urgent events, the list of control actions may only comprise causing the smart circuit breaker 30 to cut off or interrupt the electrical supply to the electrical appliance 20 or calling the emergency services, while for non-urgent events, the list of control actions may comprise causing the smart circuit breaker 30 to cut off or interrupt the electrical supply to the electrical appliance 20 or may simply comprise a push notification to let the user know that an anomalous cooking event is occurring. Alternatively, if an urgent event is detected, the processor may not present any selectable control actions with the alert and may instead automatically call the emergency services and/or cause the smart circuit breaker 30 to cut off or interrupt the electrical supply to the electrical appliance 20 without waiting for user input. This enables the processor 50 to work to act to minimise the danger posed by urgent anomalous events, without the risk that the alert may not be seen by the user. As will be appreciated, the processor 50 repeats the steps of generating an ongoing cooking event profile, comparing it to the representative cooking event profile and determining if the ongoing cooking event is anomalous multiple times during the cooking event. For example, the processor 50 may repeat these steps every hour, every thirty minutes, every ten minutes, every five minutes, every minute, every thirty seconds, or every ten seconds. The frequency at which the steps are repeated may depend on the specific use case, e.g. which type of appliance is being monitored, whether the appliance is in a domestic household or business setting, e.g. restaurant, etc. This enables ongoing monitoring of the cooking event as it progresses. It will be understood that the ongoing cooking event profiles are generated based on all sensor output data received by the processor 50 from the smart circuit breaker 30 and the temperature sensor 40 from the start of the cooking event, not only from when the previous ongoing cooking event profile was generated.

As alluded to above, the determination of the anomalousness and urgency of an ongoing cooking event may change over time as repeated determinations of ongoing cooking event profiles and subsequent comparisons to the representative cooking event profile are carried out. Naturally, most, if not all, events start off as non-anomalous and only become anomalous because they go on for a long period of time or because one parameter starts to deviate significantly from its normal range. For example, the ambient temperature may increase over time as the electrical appliance 20 is accidentally left on such that the error value generated by comparing the mean ambient temperature in the ongoing cooking event profile to that in the representative cooking event profile exceeds the threshold value.

In addition, the determined urgency of the cooking event may also change. At a first point in time, it may be the case that the cooking event is determined to be anomalous on the basis of the elapsed time of the cooking event being too long. However, this may not be sufficient to cause the cooking event to be determined to be urgent. However, if at a second point in time, the mean value of the ambient temperature may increase to such a level that the cooking event is also determined to be urgent.

Many modifications may be made to the described examples without departing from the scope of the appended claims.

1. A computer-implemented method of determining an anomalous cooking event of an electrical appliance, the method comprising:
receiving sensor output data from one or more sensors indicative of usage of the electrical appliance, the sensor output data comprising electrical powerline data from an electrical powerline sensor or sensors;
determining a start of a cooking event of the electrical appliance based on the received electrical powerline data;
determining an ongoing cooking event profile for the electrical appliance based on the sensor output data received since the determined start of the cooking event;
determining a representative cooking event profile representing normal usage of the electrical appliance,
wherein the determination uses a library of stored data indicative of usage of the electrical appliance and is based on a time of the determined start of the cooking event;
comparing the ongoing cooking event profile to the representative cooking event profile; and
determining if the ongoing cooking event is anomalous in dependence on the comparison.

2. The method of claim 1, wherein the library comprises a plurality of individual data sets relating to previous cooking events.

3. The method of claim 1, comprising determining that the ongoing cooking event has finished and then storing sensor output data related to the ongoing cooking event in the library as a new data set.

4. The method of a claim 1, wherein the representative cooking event profile is determined using a cooking event model generated by a neural network.

5. The method of claim 4, wherein the method comprises training the neural network on the data in the library.

6. The method of claim 5, comprising retraining the neural network such that the neural network is trained on data added to the library since the neural network was last trained.

7. The method of claim 1, wherein the determination of the representative cooking event profile is based on a time profile of the cooking event, wherein the time profile comprises a time of day, day of the week and month of the year of the determined start of the cooking event.

8. The method of any claim 1, wherein the one or more electrical powerline sensor or sensors are part of a smart circuit breaker.

9. The method of claim 1, wherein the one or more sensors comprise a temperature sensor.

10. The method of claim 1, comprising determining an urgency status of the cooking event if the cooking event is determined to be anomalous.

11. The method of claim 10, wherein the determination of the urgency status of the cooking event is based on a temperature measured by the temperature sensor.

12. The method of claim 1, comprising generating an alert to a user of the electrical appliance if the cooking event is determined to be anomalous.

13. The method of claim 12, wherein the alert is generated in dependence on the determined urgency status of the cooking event.

14. The method of claim 12, comprises a list of selectable control actions in response to the anomalous cooking event.

15. The method of claim 14, wherein the list of selectable control actions comprises causing the smart circuit breaker to cut off or interrupt an electrical supply to the electrical appliance and/or calling emergency services.

16. The method of claim 14, wherein the list of selectable control actions is generated in dependence on the determined urgency status of the cooking event.

17. The method of claim 14, comprising automatically selecting a control action from the list if no response is received from a user of the electrical appliance within a predetermined time period.

20. The method of claim 17, wherein the selected control action depends on the determined urgency status of the cooking event.

19. The method of claim 1, comprising repeating the steps of determining an ongoing cooking event profile, comparing the determined ongoing cooking event profile to the representative cooking event profile and determining if the ongoing cooking event profile is anomalous in dependence on the comparison.

20. The method of claim 1, wherein the step of comparing the ongoing cooking event profile to the representative cooking event profile comprises comparing a mean or instant value of a parameter of the sensor output data in the ongoing cooking event profile to a mean or instant value of the same parameter in the representative cooking event profile.

21. The method of claim 20, comprising calculating an error value based on the difference between the values of the parameter in the ongoing cooking event profile and the representative cooking event profile, and determining that the ongoing cooking event is anomalous if the error value is greater than a threshold value.

22. The method of claim 21, wherein the threshold value is defined with respect to a standard deviation of the parameter in the representative cooking event profile.

23. A non-transitory, computer readable storage medium storing instructions thereon which, when executed by one or more computer processors, cause the one or more processors to perform the method of claim 1.

24. A processor configured to carry out the method of claim 1.
